(19) United States
(12) Patent Application Publication
(10) Pub. No.: US 2005/0179353 A1
(43) Pub. Date: Aug. 18, 2005

(54) Spark plug having ground electrode with high strength and high heat resistance

(75) Inventor: Tetsuya Watanabe, Okazaki-shi (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 11/055,109

(22) Filed: Feb. 11, 2005

(30) Foreign Application Priority Data
Feb. 12, 2004 (JP) 2004-35208

(51) Int. Cl. H01T 13/20

(52) U.S. Cl. 313/141

(57) ABSTRACT

A spark plug includes a metal shell having a threaded portion with an outer diameter of 18 mm or more, an insulator, a center electrode, and a ground electrode joined to the metal shell by resistant welding. The spark plug has an improved structure in which the following dimensional relationships are defined: 0.7≦B/C≦1.0; 60°≦θ≦90°; 1.0<B/(t/sin θ)≦1.6; and 0.20<B/D<0.65, where B and C are radial thicknesses of the metal shell on a first and a second reference plane, t is a thickness of the ground electrode, θ is a mounting angle of the ground electrode to the metal shell, and D is a parameter representing a half of a difference between the outer diameter of the threaded portion and an inner diameter of the metal shell on the first reference plane.

### CROSS-REFERENCE TO RELATED APPLICATION

This application claims priority from Japanese Patent Application No. 2004-35208, filed on Feb. 12, 2004, the content of which is hereby incorporated by reference into this application.

### BACKGROUND OF THE INVENTION

1 Technical Field of the Invention

The present invention relates generally to spark plugs for gas engines. More particularly, the invention relates to a spark plug having an outer diameter of a threaded portion of a metal shell equal to or greater than 18 mm, in which a ground electrode that is joined to the metal shell by resistance welding has a high strength and a high heat resistance.

2 Description of the Related Art

Conventional spark plugs for use in gasoline engines of automobiles or gas engines of cogeneration systems generally include a tubular metal shell, an insulator, a center electrode, and a ground electrode.

The metal shell has a threaded portion for fitting the spark plug into a combustion chamber of the engine. The insulator has a center bore formed therein and is fixed in the metal shell such that an end thereof protrudes from an end of the metal shell. The center electrode is so secured in the center bore of the insulator that an end thereof protrudes from the end of the insulator. The ground electrode has a base end joined to the end of the metal shell and a tip portion that has a side face facing the end of the center electrode through a spark gap therebetween.

Such spark plugs are generally classified according to the outer diameter of the threaded portion of the metal shell. For example, a spark plug of M18 as specified in JIS (Japanese Industrial Standards) has an outer diameter of the threaded portion of the metal shell equal to 18 mm.

In recent years, gas engines for cogeneration systems, which are characterized by high compression and high power output, have been developed for the purpose of increasing the engine efficiency. Spark plugs for use in those gas engines have accordingly been required to possess high strength. To this end, the threaded portion of the metal shell in those spark plugs generally has an outer diameter of 18 mm, which is greater than an outer diameter of 14 mm or less generally used in spark plugs for use in gasoline engines of automobiles.

Moreover, the ground electrode in those spark plugs is generally subject to higher temperatures than the same in spark plugs used in gasoline engines. More specifically, the temperature of the ground electrode is generally up to 800° C. at normal load in a spark plug used in a gasoline engine; however, it generally reaches a higher extent of 850 to 900° C. at normal load in a spark plug used in a gas engine.

Accordingly, it is preferable to embed metal materials with high thermal conductivity, for example Cu, in the base material of the ground electrode of a spark plug for a gas engine, thereby enhancing heat transfer from the ground electrode to the metal shell to which the ground electrode is joined.

Otherwise, it is preferable that the entire ground electrode is made of a Ni-based alloy containing a certain amount of Al (Aluminum), thereby improving the high-temperature oxidation resistance thereof.

The ground electrode is generally joined to the metal shell by welding. More specifically, the base end of the ground electrode and the end of the metal shell are welded together by resistance welding in which a high electric current is passed through both the ends.

However, according to the results of an investigation by the inventor of the present invention, the weld strength of the ground electrode to the metal shell by resistance welding decreases as the outer diameter of the threaded portion of the metal shell increases to above 18 mm.

More specifically, with reference to FIG. 10A, when the metal shell 10 has the threaded portion with an outer diameter M of 14 mm, the end 10a of the metal shell 10 and the base end 40a of the ground electrode 40 have the approximately same thickness. As a consequence, when the ground electrode 40 is welded to the metal shell 10 by resistance welding, the heat generated by the high electric current can be effectively provided to both the base end 40a and the end 10a, thereby sufficiently melting and mixing the materials of the ground electrode 40 and the metal shell 10 at the two ends.

On the contrary, with reference to FIG. 10B, when the metal shell 10 has the threaded portion with an outer diameter M of 18 mm, the thickness of the end 10a of the metal shell 10 becomes larger than that of the base end 40a of the ground electrode 40. Therefore, when the ground electrode 40 is welded to the metal shell 10 by resistance welding, the heat generated by the high electric current can diffuse to the portion of the end 10a of the metal shell 10 that is not in contact with the base end 40a of the ground electrode 40 and dissipate in the air. Consequently, the materials of the ground electrode 40 and the metal shell 10 in their joining portions cannot be sufficiently melted and mixed.

As a result, the ground electrode 40 cannot be welded to the metal shell 10 with sufficiently high weld strength, so that it can be easily broken away from the metal shell 10.

The inventor has conducted the investigation with two different types of ground electrodes. One type is made of a plurality of metal materials including Cu that is embedded in the base material of the ground electrode; the other type is made of a Ni-based alloy containing a certain amount of Al. As a result, the above-described decrease of the weld strength of the ground electrode to the metal shell has been observed for both types of ground electrode.

One may consider, for the purpose of securing the weld strength of the ground electrode to the metal shell, performing the resistance welding in an inactive gas atmosphere. However, at the same time, this will require additional devices or apparatuses, thus resulting in an increase of fabrication cost.

### SUMMARY OF THE INVENTION

It is, therefore, a primary object of the present invention to provide a spark plug having an outer diameter of a threaded portion of a metal shell equal to or greater than 18 mm, in which a ground electrode that is joined to the metal shell by resistance welding has a high strength and a high heat resistance.

The inventor of the present invention has considered that it can be effective, in securing both the high strength and high heat resistance of the ground electrode, to define suitable ranges of dimensions of the metal shell and the mounting angle of the ground electrode to the metal shell and to specify the material and structure of the ground electrode.

The invention results from the experimental results of the investigation conducted by the inventor based on the above consideration.

According to one aspect of the invention, a spark plug is provided which includes:
a tubular metal shell having an axis, the metal shell also having an end and a threaded portion on an outer periphery thereof, the threaded portion having an outer diameter of 18 mm or more;
a hollow insulator fixed in the metal shell, the insulator having an end that protrudes from the end of the metal shell;
a center electrode secured in the insulator, the center electrode having an end that protrudes from the end of the insulator; and
a ground electrode having a base end joined to the end of the metal shell, the ground electrode also having a tip portion that faces the end of the center electrode through a spark gap, wherein the following dimensional relationships are defined:
   0.7≦B/C≦1.0; and
   0.20<B/D<0.65, where
B is a radial thickness of the metal shell on a first reference plane that is defined to extend perpendicular to the axis of the metal shell through an edge of the end of the metal shell,
C is a radial thickness of the metal shell on a second reference plane that is defined to extend parallel to and spaced 0.5 mm from the first reference plane, and
D is a parameter representing a half of a difference between the outer diameter of the threaded portion of the metal shell and an inner diameter of the metal shell on the first reference plane.

Specifying the dimensional relationships between B, C, and D as above, the radial thickness B of the metal shell is made to approximate the thickness of the ground electrode at the base end thereof in the radial direction of the metal shell.

Consequently, the heat generated by high electric current during the resistance welding of the ground electrode to the metal shell could be effectively provided to the joining portions of the base end of the ground electrode and the end of the metal shell, thereby securing a high weld strength of the ground electrode to the metal shell.

According to another aspect of the invention, a spark plug is provided which includes:
a tubular metal shell having an axis, the metal shell also having an end and a threaded portion on an outer periphery thereof, the threaded portion having an outer diameter of 18 mm or more;
a hollow insulator fixed in the metal shell, the insulator having an end that protrudes from the end of the metal shell;
a center electrode secured in the insulator, the center electrode having an end that protrudes from the end of the insulator; and
a ground electrode having a base end joined to the end of the metal shell at which the ground electrode has a cross section perpendicular to a direction of the axis of the metal shell, the cross section having a center, a first opposite pair of sides, and a second opposite pair of sides being shorter than the first opposite pair, the ground electrode also having a tip portion that faces the end of the center electrode through a spark gap,
wherein the following dimensional relationships are defined:
   0.7≦B/C≦1.0;
   60 °≦θ90°; and
   1.0<B/(t/sin θ)≦1.6, where
B is a radial thickness of the metal shell on a first reference plane that is defined to extend perpendicular to the axis of the metal shell through an edge of the end of the metal shell,
C is a radial thickness of the metal shell on a second reference plane that is defined to extend parallel to and spaced 0.5 mm from the first reference plane,
t is a thickness of the ground electrode that is a minimum distance between the first opposite pair of sides of the cross section of the ground electrode, and
θ is an angle between one of the first opposite pair of sides of the cross section of the ground electrode and a reference line that is defined to extend over the cross section of the ground electrode through the center of the cross section and intersect with the axis of the metal shell.

Specifying the dimensional relationships between B, C, t, and θ as above, the ground electrode could be welded to the metal shell with large joining portions of the base end of the ground electrode and the end of the metal shell, while preventing the base end of the ground electrode from protruding from the end of the metal shell and preventing the tip portion of the ground electrode from getting away from the end of the center electrode.

Consequently, a high weld strength of the ground electrode to the metal shell is secured, while ensuring formation of the spark gap between the tip portion of the ground electrode and the end of the center electrode.

It is preferable that the ground electrode, in the above spark plugs according to the invention, is made of a plurality of metal materials including a base metal material and a metal material that is embedded in the base metal material and has a thermal conductivity different from that of the base metal material.

The metal material embedded in the base metal material is preferably Cu. Since Cu has a high thermal conductivity, it is possible to effectively transfer heat from the ground electrode to the metal shell in operation of the engine in which the spark plug is installed.

Further, the base metal material, which may be a Ni-based alloy, preferably has a specific resistance higher than that of any other metal material of the ground electrode. As a consequence, when the ground electrode is welded to the metal shell by resistance welding, the ground electrode as a whole can withstand the heat generated by high electric current during the resistance welding.

Otherwise, the ground electrode is preferably made of a Ni-based alloy containing Al (Aluminum) in an amount of 1 wt % or more. As a result, a tough oxide layer can be formed on the outer surface of the ground electrode, thereby improving the high-temperature oxidation resistance of the ground electrode.

### BRIEF DESCRIPTION OF THE DRAWINGS

The present invention will be understood more fully from the detailed description given hereinafter and from the accompanying drawings of the preferred embodiments of the invention, which, however, should not be taken to limit the invention to the specific embodiments but are for the purpose of explanation and understanding only.

In the accompanying drawings:

FIG. 1 is a partially cross-sectional side view showing an overall structure of a spark plug according to the first embodiment of the invention;

FIG. 2A is a cross-sectional side view of a ground electrode of the spark plug of FIG. 1 and FIG. 2B is a view in cross-section along lines C-C of FIG. 2A, both of which illustrate a multi-layer structure of the ground electrode;

FIG. 3A is an enlarged view showing a portion A of the spark plug of FIG. 1 which is indicated with a circle in FIG. 1;

FIG. 3B is a view in cross-section along lines C-C of FIG. 3A;

FIG. 4 is an enlarged view illustrating a metal shell of the spark plug of FIG. 1 which has an end with a large radial thickness;

FIG. 5 is a graphical representation showing the relationship between a dimensional ratio B/D and a welding strength of a resistance welding between the ground electrode and the metal shell of the spark plug of FIG. 1;

FIGS. 6A-6B are views in partially cross-section illustrating orientation of the ground electrode with respective to the metal shell in the spark plug of FIG. 1 with different mounting angles;

FIG. 7 is a graphical representation showing the relationship between a dimensional ratio B/S and the welding strength of the resistance welding between the ground electrode and the metal shell of the spark plug of FIG. 1;

FIG. 8 is an enlarged view illustrating a metal shell of the spark plug of FIG. 1 which has an outer surface tapering toward an end thereof;

FIG. 9 includes three cross-sectional views illustrating different embodiments of cross section of the ground electrode of the spark plug of FIG. 1; and

FIGS. 10A-10B are views illustrating a problem concerning a welding strength of a resistance welding between the ground electrode and the metal shell of a spark plug.

### DESCRIPTION OF THE PREFERRED EMBODIMENTS

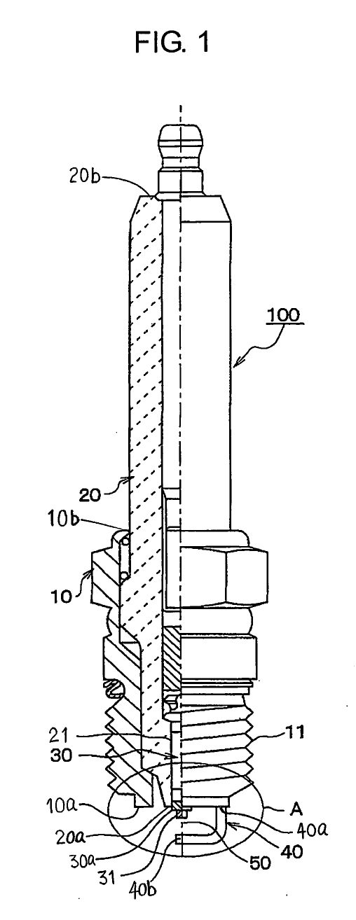

The preferred embodiments of the present invention will be described hereinafter with reference to FIGS. 1-10.

It should be noted that, for the sake of clarity and understanding, identical components having identical functions in different embodiments of the invention have been marked, where possible, with the same reference numerals in each of the figures.

### First Embodiment

FIG. 1 shows an overall structure of a spark plug 100 according to the first embodiment of the invention.

The spark plug 100 is designed for use in gas engines of cogeneration systems. The installation of the spark plug 100 in a gas engine is achieved by fitting it into a combustion chamber (not shown) of the engine through a threaded bore provided in the engine head (not shown).

As shown in FIG. 1, the spark plug 100 essentially includes a metal shell 10, an insulator 20, a center electrode 30, and a ground electrode 40.

The tubular metal shell 10 is made of a conductive metal material, for example low-carbon steel. The metal shell 10 has a threaded portion 11 on the outer periphery thereof for fitting the spark plug 100 into the combustion chamber of the engine as described above.

The threaded portion 11 of the metal shell 10 has an outer diameter of 18 mm or more. This range corresponds to the range of M18 or more as specified in JIS (Japanese Industrial Standards).

The insulator 20, which is made of alumina ceramic (Al₂O₃), is fixed and partially contained in the metal shell 10 such that an end 20a of the insulator 20 protrudes from an end 10a of the metal shell 10 while the other end 20b of the insulator 20 protrudes from the other end 10b of the metal shell 10.

The columnar center electrode 30 is secured in a center bore 21 of the insulator 20, so that it is electrically isolated from the metal shell 10. The center electrode 30 is partially included in the metal shell 10 together with the insulator 20 such that an end 30a of the center electrode 30 protrudes from the end 20a of the insulator 20.

The center electrode 30 is made of a highly heat conductive metal material such as Cu as the core material and a highly heat-resistant, corrosion-resistant metal material such as a Ni (Nickel)-based alloy as the clad material.

To the end 30a of the center electrode 30, a noble metal chip 31 is joined which serves as a sparking member of the spark plug 100.

In this embodiment, the cylindrical noble metal chip 31 is made, preferably, of Ir (Iridium)-based alloy and joined to the end 30a of the center electrode 30 by laser welding.

The columnar ground electrode 40 is joined, at a base end 40a thereof, to the end 10a of the metal shell 10 by resistance welding. The ground electrode 40 is bent to an L-shape so as to have a tip portion 40b that has a side face facing the noble metal chip 31 through a spark gap 50.

In this embodiment, the columnar ground electrode 40 has a rectangular cross section perpendicular to a lengthwise direction thereof.

Moreover, as described previously, to enhance heat transfer from the ground electrode 40 to the metal shell 10, the ground electrode 40 is made, preferably, of a plurality of metal materials.

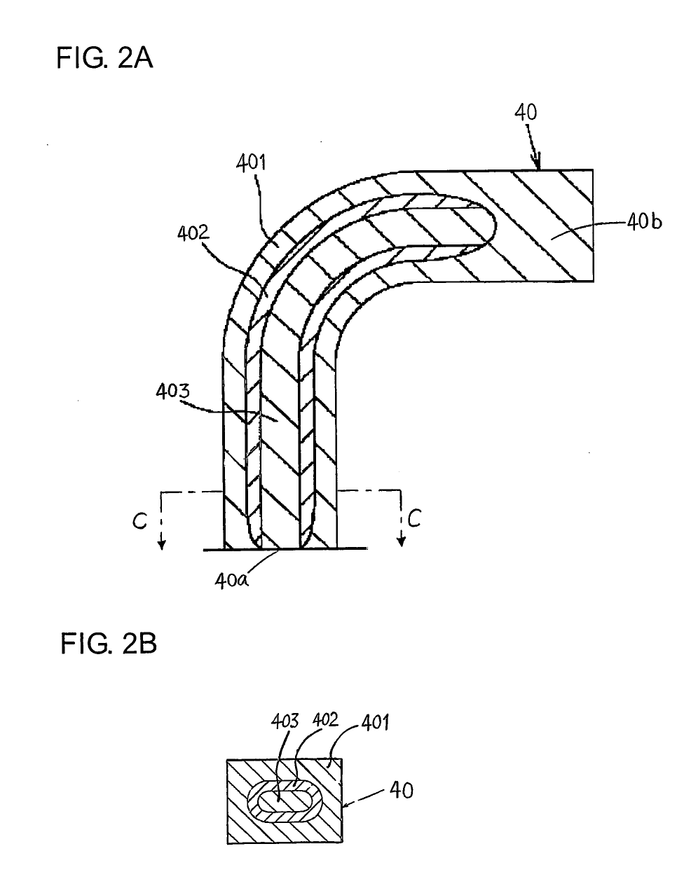

More specifically, with reference to FIGS. 2A-2B, the ground electrode 40 includes three different metal layers, i.e., the first layer 401 of Inconel (registered trade mark), the second layer 402 of Cu, and the third layer 403 of Ni. The first layer 401 embeds the second layer 402 therein, while the third layer 403 is embedded in the second layer 402. As to more details about the multi-layer structure of the ground electrode 40, one can refer to Japanese Unexamined Patent Publication No. 1999-111426, the disclosure of which is totally incorporated herein by reference.

Among the three metal materials of the ground electrode 40, Inconel, which is a Ni-based alloy and serves as the base metal material of the ground electrode 40, has a higher specific resistance than Cu and Ni and a low thermal conductivity. Therefore, when the ground electrode 40 is welded to the metal shell 10 by resistance welding, the melted Cu and Ni, which compose the second and third layers 402 and 403 respectively, can be prevented from flowing out from the first layer 401. Consequently, the ground electrode 40 as a whole can withstand the heat that is generated by high electric current during the resistance welding.

Moreover, since Cu has a high thermal conductivity, it is possible to effectively transfer heat from the ground electrode 40 to the metal shell 10 in operation of the gas engine in which the spark plug 100 is installed.

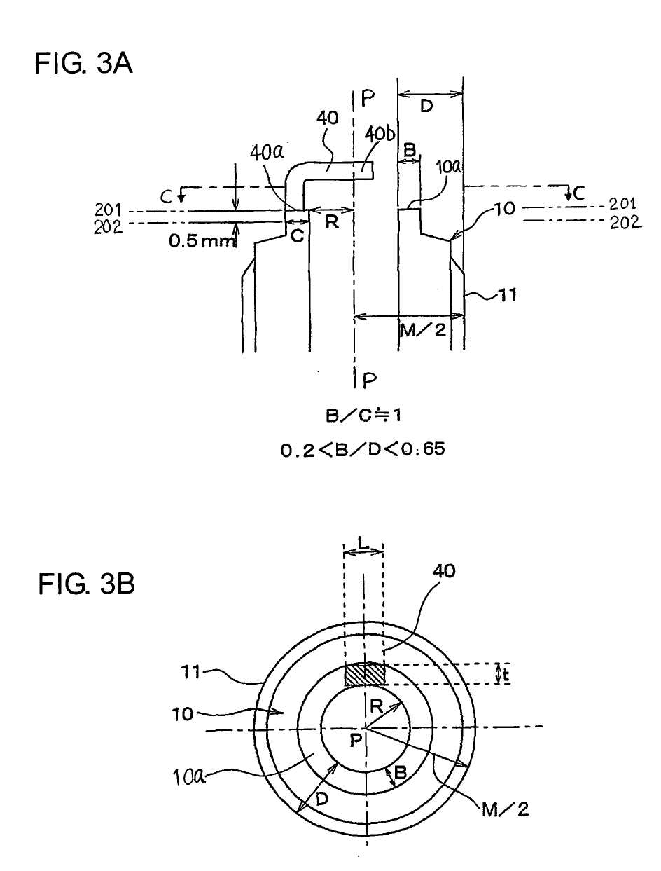

Referring now to FIG. 3A, the tubular metal shell 10 has an axis P as indicated by the single-dot chained line in the figure.

The metal shell 10 has an inner radius R on a first reference plane 201 that is defined to extend perpendicular to the axis P through an edge of the end 10a of the metal shell 10. On the first reference plane 201, the metal shell 10 has a radial thickness B in a range, for example of 2.0 to 2.2 mm.

The metal shell 10 has also a radial thickness C on a second reference plane 202 that is defined to extend parallel to and spaced 0.5 mm from the first reference plane 201. The radial thickness C of the metal shell 10 is in a range, for example, of 2.0 to 2.2 mm.

The ratio B/C between the two radial thicknesses of the metal shell 10 represents the taper degree of the outer surface of the metal shell 10 in a range from the first reference plane 201 to the second reference plane 202.

More specifically, the ratio B/C of equal to 1.0 represents that the outer surface of the metal shell 10 is parallel to the axis P of the same in the range of the first reference plane 201 to the second reference plane 202. Otherwise, the outer surface of the metal shell 10 is more highly tapered from the second reference plane 202 to the first reference plane 201 with the smaller value of B/C.

In this embodiment, the value of B/C is approximately equal to 1.0, i.e., the outer surface of the metal shell 10 is approximately parallel to the axis P in the range of the first reference plane 201 to the second reference plane 202.

Referring to FIG. 3B together with FIG. 3A, the ground electrode 40 has a cross section perpendicular to the direction of the axis P of the metal shell 10, in which a first opposite pair of sides each has a length L, and a second opposite pair of sides each has a length t that is less than L. The lengths L and t will be referred to as the width L and the thickness t of the ground electrode 40, respectively, hereinafter.

Further, a parameter D is employed to represent a half of the difference between the outer diameter M of the threaded portion 11 of the metal shell 10 and the inner diameter of the metal shell 10 on the first reference plane 201. In other words, the parameter D is equal to (M/2)−R.

In this embodiment, the parameter D is in a range, for example, of 4.4 to 4.5 mm. Accordingly, the ratio B/D between the radial thickness B of the metal shell 10 and the parameter D is in a range of 0.44 to 0.50.

As the ratio B/D increases, the radial thickness B of the metal shell 10 on the first reference plane 201 increases with respect to given inner radius R and outer diameter D of the same, resulting in a larger portion of the end 10a of metal shell 10 to which no the base end 40a of the ground electrode 40 is to be joined. As a result, the heat generated by high electric current in the resistance welding of the ground electrode 40 to the metal shell 10 cannot be effectively provided to the joining portions of the metal shell 10 and the ground electrode 40.

On the contrary, as the ratio B/D decreases, the radial thickness B of the metal shell 10 decreases with respect to given inner radius R and outer diameter D, resulting in a smaller space on the end 10a of the metal shell 10 available for the resistance welding. As a result, it becomes impossible to join the base end 40a of the ground electrode 40 to the end 10a of the metal shell 10.

Accordingly, there exists a preferable range of the radio B/D which has been determined based on the results of a weld strength test conducted by the inventor of the present invention to be described below.

In the weld strength test, weld strength of the resistance welding between the ground electrode 40 and the metal shell 10 was evaluated with different sample metal shells 10 and sample ground electrodes 40.

Specifically, a sample ground electrode 40 and a sample metal shell 10 were joined together by resistance welding and fixed to two different holders respectively. Then, the two holders were pulled toward opposite directions until the sample ground electrode 40 was broken away from the sample metal shell 10 or the sample ground electrode 40 itself fractured, and the then tensile strength was measured.

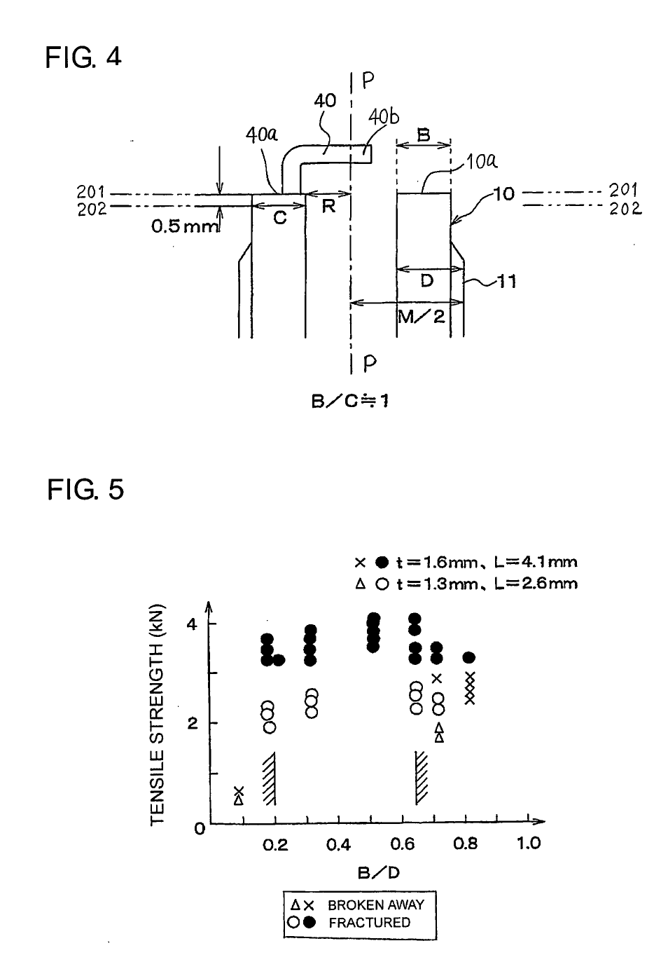

Sample metal shells 10 tested each had the shape as shown either in FIG. 3A or in FIG. 4. In sample metal shells 10 that had the shape as shown in FIG. 3A, as described previously, the ratio B/C was equal to 1.0, both the radial thicknesses B and C were in the range of 2.0 to 2.2 mm, the parameter D was in the range of 4.4 to 4.5 mm, and the ratio B/D was in a range of 0.44 to 0.50.

On the other hand, in sample metal shells 10 having the shape as shown in FIG. 4, which were tested for the purpose of comparison, the ratio B/C was equal to 1.0, both the radial thicknesses B and C were in a range of 3.1 to 3.4 mm, the parameter D was in range of 4.4 to 4.5 mm, and the ratio B/D was in a range of 0.65 to 0.78.

As to the ground electrode 40, two different types of sample ground electrodes were tested in combination with the above different sample metal shells 10. One type had the width L of 4.1 mm and the thickness t of 1.6 mm; the other type had the width L of 2.6 mm and the thickness t of 1.3 mm. It should be noted that both the thicknesses t of 1.6 mm and 1.3 mm were made less than the radial thick B of any of the sample metal shells 10.

The weld strength test results are shown in FIG. 5. In the figure, the horizontal axis indicates the ratio B/D; the vertical one indicates the resultant tensile strength with the plot of “X” for the sample ground electrodes 40 that had the width L of 4.1 mm and the thickness t of 1.6 mm and were broken away from the sample metal shell 10, the plot of “●” for the those that had L of 4.1 mm and t of 1.6 mm and fractured, the plot of “Δ” for those that had L of 2.6 mm and t of 1.3 mm and were broken away from the sample metal shell 10, the plot of “◯” that had L of 2.6 mm and t of 1.3 mm and fractured, respectively.

As can be seen from FIG. 5, when the ratio B/D was too large, i.e., the tested sample metal shell 10 had a too large radial thickness B, the sample ground electrode 40 was broken away from the sample metal shell 10.

Moreover, when the ratio B/D was too small, i.e., the tested sample metal shell 10 had a too small radial thickness B, the sample ground electrode 40 was also broken away from the sample metal shell.

It should be noted that, in addition to the sample metal shells 10 as described above, two sample metal shells 10, each of which had the radial thickness B of less than the thickness t of the mating sample ground electrode 40, were also tested for comparison. With the two sample metal shells 10, very low weld strength was obtained as designated by the two plots of “X” and “Δ” in the left-down corner of FIG. 5.

On the contrary, as can be seen from FIG. 5, when the ratio B/D was in a range of 0.20 to 0.65, the weld strength obtained was so high that the ground electrode 40 fractured before being broken away from the sample metal shell 10.

Accordingly, to secure high weld strength of the resistance welding between the ground electrode 40 and the metal shell 10, it is preferable that the ratio B/D is in the range of 0.20 to 0.65.

When the ratio B/D falls in the above range, the thickness t of the ground electrode 40 and the radial thickness B of the metal shell 10 have the approximately same value, so that the heat generated by high electric current during the resistance welding can be effectively provided to the joining portions of the ground electrode 40 and the metal shell 10, thereby sufficiently melting and mixing the materials in those portions.

Based on the above results, further investigation was directed to determine the suitable orientation of the base end 40a of the ground electrode 40 to the end 10a of the metal shell 10 for the resistance welding therebetween.

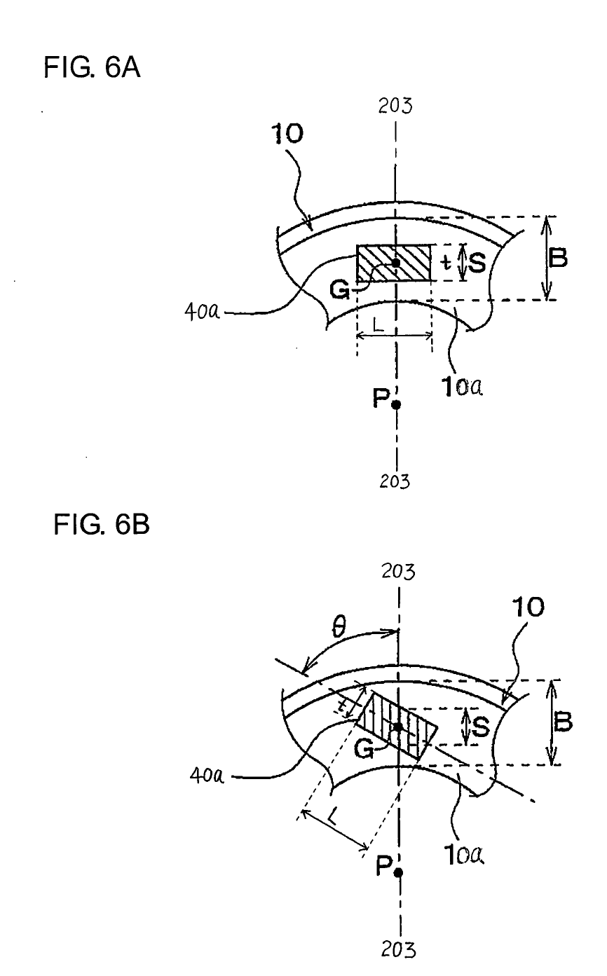

Referring to FIGS. 6A-6B, the columnar ground electrode 40 has, at the base end 40a thereof, the cross section perpendicular to the direction of the axis P which has a center G, the first opposite pair of sides, and the second opposite pair of sides being shorter than the first opposite pair.

Additionally, in those figures, there is shown a reference line 203 that is defined to extend over the cross section through the center G thereof and intersect with the axis P.

In FIG. 6A, the ground electrode 40 is oriented with respect to the metal shell 10 such that the first opposite pair of sides of the cross section of the ground electrode 40 is perpendicular to the reference line 203. Consequently, the distance S between the first opposite pair of sides in the direction of the reference line 203 is equal to the thickness t of the ground electrode, which is the length of the second opposite pair of sides as described previously.

On the other hand, in FIG. 6B, the ground electrode 40 is oriented with respect to the metal shell 10 with a mounting angle θ between the first opposite pair of sides of the cross section of the ground electrode 40 and the reference line 203. As a consequence, the distance S between the first opposite pair of sides in the direction of the reference line 203 becomes equal to t/sin θ.

When the mounting angle θ has a small value of less than 60, for example 30°, the tip portion 40b of the ground electrode 40 will get away from the noble metal chip 31, so that it cannot form the spark gap 50 together with the noble metal chip 31. Therefore, the mounting angle θ is preferably not less than 60°.

Moreover, to have the tip portion 40b of the ground electrode 40 being aligned with the noble metal chip 31 in the direction of the axis P, it is preferable that the mounting angle θ is equal to 90°.

Accordingly, the mounting angle θ is preferably in a range of 60 to 90°.

In order to further reliably secure the weld strength of the ground electrode 40 to the metal shell 10, the inventor has investigated the effect of a ratio B/S(S=t/sin θ) on the weld strength.

In the investigation, sample ground electrodes 40 of the two different types as described above were tested in combination with different sample metal shells 10 each having the ratio B/D in the range of 0.20 to 0.65.

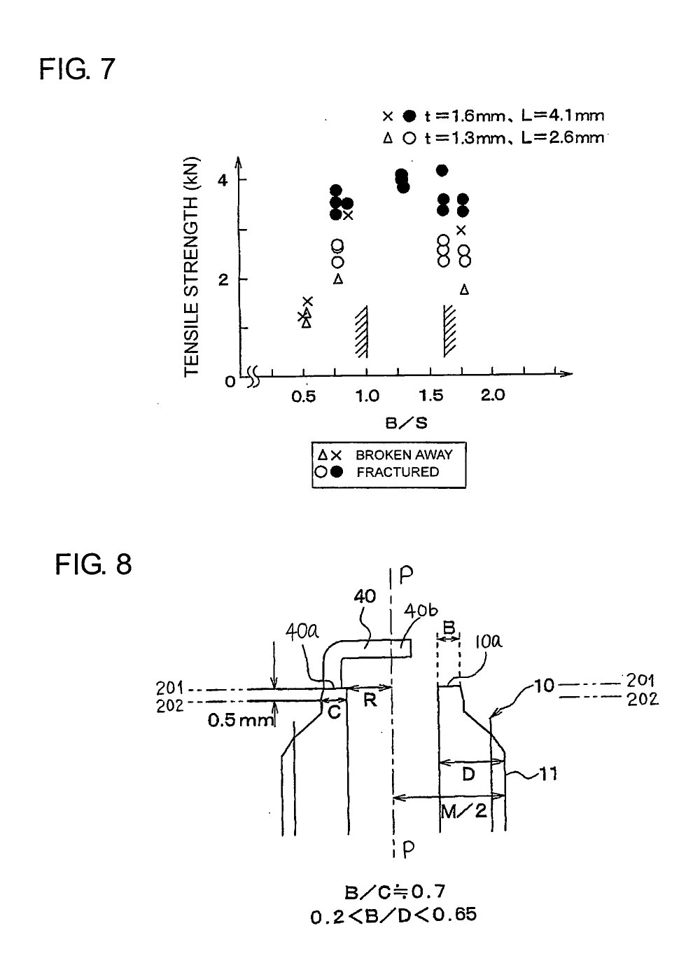

FIG. 7 shows the investigation results. In the figure, the horizontal axis indicates the ratio B/S; the vertical one indicates the resultant tensile strength with the plot of “X” for the sample ground electrodes 40 that had the width L of 4.1 mm and the thickness t of 1.6 mm and were broken away from the sample metal shell 10, the plot of “●” for the those that had L of 4.1 mm and t of 1.6 mm and fractured, the plot of “Δ” for those that had L of 2.6 mm and t of 1.3 mm and were broken away from the sample metal shell 10, the plot of “◯” that had L of 2.6 mm and t of 1.3 mm and fractured, respectively.

As can be seen from FIG. 7, when the ratio B/S was smaller than 1.0, the weld strength of the resistance welding was so low that the sample ground electrode 40 was broken away from the mating sample metal shell 10. This is because the end 10a of the sample metal shell 10 could not completely cover the base end 40a of the sample metal shell 40, in other words, the base end 40a protruded from the end 10a, thereby resulting in the low weld strength therebetween.

Moreover, when the ratio B/S was greater than 1.6, the weld strength of the resistance welding was also so low that the sample ground electrode 40 was broken away from the mating sample metal shell 10. This is because the radial thickness B of the metal shell 10 was so large that the heat generated by high electric current during the resistance welding could not be effectively provided to the joining portions of the base end 40a of the sample ground electrode 40 and the end 10a of the sample metal shell 10.

On the contrary, when the ratio B/S was in a range of 1.0 to 1.6, the weld strength of the resistance welding was so high that the sample ground electrode 40 fractured before being broken away from the mating sample metal shell 10.

Accordingly, to secure high weld strength of the resistance welding between the ground electrode 40 and the metal shell 10, it is preferable that the ratio B/S is in the range of 1.0 to 1.6.

To sum up, the spark plug 100 according to the present embodiment, which includes the metal shell 10 having the threaded portion 11 with an outer diameter M of 18 mm or more and a ground electrode 40 joined to the metal shell 10 by resistance welding, has an improved structure characterized by the following dimensional relationships:
the ratio B/C, between the radial thicknesses of the metal shell 10 on the first and second reference planes 201 and 202, is equal to 1.0;
the ratio B/D, between the radial thickness B of the metal shell 10 on the first reference plane 201 and the parameter D that represents a half of the difference between the outer diameter M of the threaded portion 11 and the inner diameter 2R of the metal shell 10 on the first reference plane 201, is in the range of 0.20 to 0.65;
the mounting angle θ, between the first opposite pair of sides of the cross section of the ground electrode 40 perpendicular to the direction of the axis P and the reference line 203, is in the range of 60 to 90°; and
the ratio B/S (i.e., B/(t/sin θ)), between the radial thickness B of the metal shell 10 on the first reference plane 201 and the distance S between the first opposite pair of sides of the cross section of the ground electrode 40 in the direction of the reference line 203, is in the range of 1.0 to 1.6.

The improved structure ensures a high weld strength of the resistance welding between the ground electrode 40 and the metal shell 10.

Moreover, in the spark plug 100, the ground electrode 40 is made preferably of a plurality of metal materials including the base metal material of Inconel and Cu that is embedded in the base metal material, thereby securing a high heat resistance of the ground electrode 40.

### Second Embodiment

In the spark plug 100 according to the previous embodiment, the ratio B/C is equal to 1.0, in other words, the outer surface of the metal shell 10 is parallel to the axis P of the same in the range of the first reference plane 201 to the second reference plane 202.

In this embodiment, a spark plug 100 is provided in which the ratio B/C is less than 1.0 but greater than 0.7. In other words, the outer surface of the metal shell 10 is, as shown in FIG. 8, tapered from the second reference plane 202 to the first reference plane 201.

With such tapered metal shell 10, the inventor of the present invention has obtained, through experimental investigation, the same tendencies and dimensional relationships as the metal shell 10 in the previous embodiment.

Accordingly, it is preferable for the spark plug 100 according to the invention that 0.7≦B/C≦1.0.

### Other Embodiments

While the above particular embodiments of the invention have been shown and described, it will be understood by those who practice the invention and those skilled in the art that various modifications, changes, and improvements may be made to the invention without departing from the spirit of the disclosed concept.

For example, in the previous embodiments, only one noble metal chip 31 is joined to the end 30a of the center electrode 30.

However, in addition to the noble metal chip 31, the spark plug 100 may also include another noble metal chip that is joined to the side face of the tip potion 40b of the ground electrode 40 by, for example, resistance welding so as to face the noble metal chip 31 through the spark gap 50. The noble metal chip may be made of a Pt-based alloy and have a cylindrical shape.

Moreover, in the previous embodiments, the ground electrode 40 includes the three metal layers which are composed of Inconel, Cu, and Ni, respectively. However, the three metal layers may be composed of other metal materials.

Furthermore, instead of the above multi-layer structure, the entire ground electrode 40 may be made of a Ni-based alloy containing Al (Aluminum) in an amount, for example, of 1 wt % or more. As a result, a tough oxide layer can be formed on the outer surface of the ground electrode 40, thereby improving the high-temperature oxidation resistance of the ground electrode 40.

It should be noted that, the inventor of the present invention has performed an experimental investigation with ground electrodes 40 that are made of the above-described Ni-based alloy containing Al in an amount of 1, 2, or 3%, and obtained the same tendencies and dimensional relationships as with the ground electrode 40 in the previous embodiments.

In addition, in the previous embodiments, the ground electrode 40 has the columnar shape and the rectangular cross section.

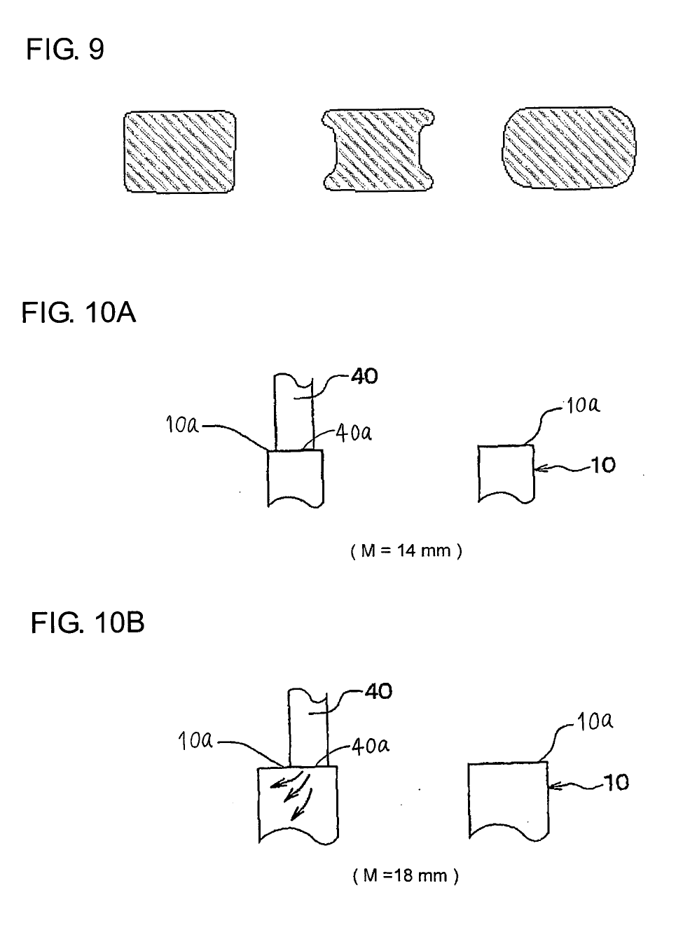

However, the ground electrode 40 may have various shapes of cross section, for example, as shown in FIG. 9.

Such modifications, changes, and improvements within the skill of the art are intended to be covered by the appended claims.

1. A spark plug comprising:
a tubular metal shell having an axis, said metal shell also having an end and a threaded portion on an outer periphery thereof, the threaded portion having an outer diameter of 18 mm or more;
an insulator fixed in said metal shell;
a center electrode secured in said insulator; and
a ground electrode having a base end joined to the end of said metal shell, said ground electrode also having a tip portion that faces an end of said center electrode through a spark gap,
wherein the following dimensional relationships are defined:
0.7≦B/C≦1.0; and
0.20<B/D<0.65, where
B is a radial thickness of said metal shell on a first reference plane that is defined to extend perpendicular to the axis of said metal shell through an edge of the end of said metal shell,
C is a radial thickness of said metal shell on a second reference plane that is defined to extend parallel to and spaced 0.5 mm from the first reference plane, and
D is a parameter representing a half of a difference between the outer diameter of the threaded portion of said metal shell and an inner diameter of said metal shell on the first reference plane.

2. The spark plug as set forth in claim 1, wherein the ground electrode is made of a plurality of metal materials including a base metal material and a metal material that is embedded in the base metal material and has a thermal conductivity different from that of the base metal material.

3. The spark plug as set forth in claim 2, wherein the base metal material has a specific resistance higher than that of any other metal material of said ground electrode.

4. The spark plug as set forth in claim 3, wherein the base metal material is a Ni-based alloy.

5. The spark plug as set forth in claim 4, wherein Cu is embedded in the base material.

6. The spark plug as set forth in claim 2, wherein the base metal material is a Ni-based alloy.

7. The spark plug as set forth in claim 2, wherein Cu is embedded in the base material.

8. The spark plug as set forth in claim 1, wherein said ground electrode is made of a Ni-based alloy containing Al in an amount of 1 wt % or more.

9. The spark plug as set forth in claim 1, wherein the radial thickness B of said metal shell is made equal to the radial thickness C of the same, so that said metal shell has an outer surface parallel to the axis thereof in a range from the first reference plane to the second reference plane.

10. The spark plug as set forth in claim 1, wherein the radial thicknesses B and C of said metal shell satisfy a dimensional relationship of 0.7≦B/C<1.0, so that said metal shell has an outer surface tapering from the second reference plane to the first reference plane.

11. A spark plug comprising:
a tubular metal shell having an axis, said metal shell also having an end and a threaded portion on an outer periphery thereof, the threaded portion having an outer diameter of 18 mm or more;
an insulator fixed in said metal shell;
a center electrode secured in said insulator; and
a ground electrode having a base end joined to the end of said metal shell at which said ground electrode has a cross section perpendicular to a direction of the axis of said metal shell, the cross section having a center, a first opposite pair of sides, and a second opposite pair of sides being shorter than the first opposite pair, said ground electrode also having a tip portion that faces an end of said center electrode through a spark gap,
wherein the following dimensional relationships are defined:
0.7≦B/C≦1.0;
60°≦θ≦90°; and
1.0<B/(t/sin θ)≦1.6, where
B is a radial thickness of said metal shell on a first reference plane that is defined to extend perpendicular to the axis of said metal shell through an edge of the end of said metal shell,
C is a radial thickness of said metal shell on a second reference plane that is defined to extend parallel to and spaced 0.5 mm from the first reference plane,
t is a thickness of said ground electrode that is a minimum distance between the first opposite pair of sides of the cross section of said ground electrode, and
θ is an angle between one of the first opposite pair of sides of the cross section of said ground electrode and a reference line that is defined to extend over the cross section of said ground electrode through the center of the cross section and intersect with the axis of said metal shell.

12. The spark plug as set forth in claim 11, wherein the following dimensional relationship is defined:
0.20<B/D<0.65,
where D is a parameter representing a half of a difference between the outer diameter of the threaded portion of said metal shell and an inner diameter of said metal shell on the first reference plane.

13. The spark plug as set forth in claim 11, wherein the ground electrode is made of a plurality of metal materials including a base metal material and a metal material that is embedded in the base metal material and has a thermal conductivity different from that of the base metal material.

14. The spark plug as set forth in claim 13, wherein the base metal material has a specific resistance higher than that of any other metal material of said ground electrode.

15. The spark plug as set forth in claim 14, wherein the base metal material is a Ni-based alloy.

16. The spark plug as set forth in claim 15, wherein Cu is embedded in the base material.

17. The spark plug as set forth in claim 13, wherein the base metal material is a Ni-based alloy.

18. The spark plug as set forth in claim 13, wherein Cu is embedded in the base material.

19. The spark plug as set forth in claim 11, wherein said ground electrode is made of a Ni-based alloy containing Al in an amount of 1 wt % or more.

20. The spark plug as set forth in claim 11, wherein the radial thickness B of said metal shell is made equal to the radial thickness C of the same, so that said metal shell has an outer surface parallel to the axis thereof in a range from the first reference plane to the second reference plane.

21. The spark plug as set forth in claim 11, wherein the radial thicknesses B and C of said metal shell satisfy a dimensional relationship of 0.7≦B/C<1.0, so that said metal shell has an outer surface tapering from the second reference plane to the first reference plane.
